(19) United States
(12) Patent Application Publication
(10) Pub. No.: US 2011/0169970 A1
(43) Pub. Date: Jul. 14, 2011

(54) System and Method for Data Acquisition and Processing

(76) Inventor: Philip Wesby, Stratford-upon-Avon (GB)

(21) Appl. No.: 12/599,113

(22) PCT Filed: May 7, 2008
(86) PCT No.: PCT/GB2008/001574

§ 371 Date: Nov. 6, 2009

(30) Foreign Application Priority Data
May 8, 2007 (GB) 0708813.1

(51) Int. Cl. H04N 5/225

(52) U.S. Cl. 348/207.11; 348/207.1; 348/E05.042

(57) ABSTRACT

A system and method for data acquisition and processing is described which can form the basis of online gaming. Encoded datagram images are captured from a computer screen or a printed document using a mobile phone or PDA or fixed line device and processed relative to a stored profile and then transmitted to a remote server to be decoded. The received datagram is read and compared with one of a plurality of stored datagram images and or decoded according to specific attributes of the datagram image. The method makes possible the capture and transmission and processing of datagrams to access services such as to cause the download of specific software such as a software application. In one embodiment this may comprise an online casino application where a player receives the software to play as well as a certain amount of credit. In a separate gaming application, the datagrams may be unique such that a player captures and transmits a datagram to find whether it is a winning datagram. The datagrams may be black and white or colour in which case they may comprise hidden colour codes which can be extracted by the decoding algorithms in the image-capturing device or in the remote server. In a separate embodiment, the method may be combined with television advertising such that viewers need only capture a displayed datagram from the television screen and send it to a published or encoded IP address or phone number so that they can access information about advertised products.

### BACKGROUND OF THE INVENTION

The current invention relates to a system and method for data acquisition and processing which can form the basis of online gaming and or accessing downloadable content.

In particular, the invention relates to a system and method for capturing a printed or displayed datagram wherein the capture and decoding of the datagram may be done by the capturing device and or by a remote data processing server and wherein the decoding causes a dataset to be sent to the capturing device. The method makes possible the convenient access of downloadable content such as an online gaming application or information about televised products and services. In the context of this document the word datagram can mean a complex pixellated image or a picture image comprising embedded patterns of polygons, or a bar code or a combination of characters and or lines and or polygons.

This patent application extends the invention of an earlier patent application United Kingdom Patent Application 0619761.0 by the same applicant entitled System and Method for Data Acquisition and Processing having priority date Oct. 6, 2006. In this patent application is taught the method of using datagrams and combining these with user profiles stored within the data capture device, such as a mobile phone or PDA, to create a range of differentiated services.

The current invention can be considered as key inventive extensions of this technology towards the use of the encoded datagram capturing or receiving device—the wireless or fixed line terminal—as a means to access downloadable content such as an online gaming application or data about products shown on television during a commercial break. In addition, the method may itself form the basis of an exciting gambling game in which the datagrams may be unique such that a player captures and transmits a datagram to find whether it is a winning datagram.

Today, mobile network operators are seeking business solutions and technologies which exploit the untapped potential of the mobile phone or PDA or wireless laptop in order to render it as the intelligent device for desirable consumer and business oriented transaction services. The mobile phone is becoming the essential primary and central communications device which is capable of capturing images using camera technology as well as receiving emails. The increasing resolution of camera technology is also making the transmission of image data across the network more acceptable.

Nevertheless, many challenges are facing the mobile network operators as consumers seek data-rich and focussed information services and progressively view the mobile operators as managed high-capacity bit pipes offering multi-bearer (GSM, GPRS, 3G, WLAN, WIMAX et al) access networks. Even the search engine companies themselves are offering relatively few solutions which can be offered by way of the mobile phone to reduce churn and increase subscriber loyalty. Current initiatives merely involve directing adverts to Internet web surfers based upon their history of surfing. A business model based upon generally random wanderings through the internet faces many challenges.

The mobile phone comprises several key technical components which are not successfully exploited to their full. The hi-resolution digital camera may be able to capture photographs, but the average wireless subscriber is still unwilling to transmit these images to family and friends over the network because of the preconceived high costs of the data transmission. Often these preconceived high costs are misconceptions but they represent a real barrier to the use of the network as an image or MMS data carrier, for which networks have been planned to high capacity for. The same argument is relevant to GPRS data transmission in general which is also not fully exploited to its intended capacity.

Clearly, there is a need for a technology and business case which maximises the use of networks for data transmission. This business case must also address the preconception of the cost of transmitting data through the use of a technology which delivers a highly profitable third party service so effectively that the third party will pay for the use of the mobile and fixed line data network.

Today, many subscribers enjoy playing online gambling games such as online casinos. Many challenges exist for the consumer who needs to find and download and install the gaming application for their particular wireless device. This greatly limits the adoption of this online gaming application by the market, due to the inconvenience and complexity of installing the gaming application. If it were possible to greatly simplify the access and download and installation of the gaming software, it would enable more players to enjoy playing online games.

In other areas of gaming such as lottery tickets, consumers are becoming bored with conventional tickets and would greatly enjoy a new and exciting image-based lottery game. If a game based on uniquely coded datagrams could be created or a game based upon an image with changing data such as a count-down timer, the capture and processing of the datagram or image could form the basis of a new player experience.

Wherever a consumer or subscriber wants information about a product or service which is advertised on television, modern systems use a remote control feature such as the red button on SKY TV. This enables viewers to request information about advertised products and services. The red button feature may be used during a televised program to access information about the program content. The challenge with the red button feature is that the program screen changes to show the linked content when the button is pressed. If it were possible to incorporate the datagram as an on-screen feature, subscribers could capture the datagram when it is displayed using a handheld device and cause the sought information about the advertised product or service or the desired content to be transmitted to a pre-registered email address or sent to the capturing device directly.

In game shows on television, viewers are asked to vote for their favourite player. This generally involves sending a text message to a particular telephone number. Even today, many people are reluctant to use the texting feature of the mobile phone as they find it difficult to use. If the game show used an on-screen display of a datagram for each candidate, the voting process would be much easier. In such a case a viewer need only capture the datagram from the screen corresponding to one of the participants and send it to a particular number.

In general, obtaining the number to which a picture message or datagram should be sent is sometimes confusing and time consuming. It would be highly desirable if a method could be created which avoided the need for keying in a contact number. Consequently, it is equally possible to envisage that accessing a product or service or downloadable content can be triggered by capturing a first datagram and sending this to a single pre-programmed number. The receipt and processing of this datagram by the remote server at the single central number then causes a software application to be sent back to the sender and the programming of the capturing device with the particular number corresponding to the game show to which subsequent datagrams are to be sent.

In other areas such as with printed datagrams, a particular combination of colours used in the datagram and the software control of the optics of the capturing device which may amplify certain frequency ranges such as yellow or blue for example and filter out other colours such as green and red, makes possible a means to authenticate that a datagram is indeed genuine. Similarly the application to cause a specific control of the optics to decode the coloured datagram may be accessed by capturing the general image of the datagram in the first place thus creating a 2-stage process where necessary.

Further to the limitations of existing methods used for accessing software applications such as online gaming and content about advertised products and services, and so far as is known, no optimum system and method for data acquisition and processing is presently available which is directed towards the specific needs of this problem area as outlined.

### OBJECTS OF THE INVENTION

Accordingly, it is an object of the present invention to provide an improved system and method for data acquisition and processing which serves to use a wireless or fixed line device to capture a printed or electronically displayed datagram and transmit this to a remote server for decoding wherein the server then causes the transmission of a software application back to the sender, thereby providing a simple method to install desired content onto a capturing device in a simple and efficient way.

It is a further object of one embodiment of the present invention to provide a system and method for data acquisition and processing wherein captured datagrams are received by a remote server and decoded and combined with data of the sender such as the IP address or mobile phone number or multimedia computer number and wherein the server then transmits a software application back to the sender and thereby enable the device to operate the application.

It is a further object of one embodiment of the present invention to provide a system and method for data acquisition and processing which is suited to access content such as images or games and to access gaming applications such as an online casino and or other gambling games wherein the request to access and download the gaming application is effected by simply transmitting a datagram to a specific network IP address or phone number.

It is a further object of one embodiment of the present invention to provide a system and method for data acquisition and processing which greatly simplifies the process of accessing wireless software applications such as online gaming applications such as an online casino wherein the installation of the application is caused by simply capturing and transmitting a datagram to a particular number.

It Is a further object of one embodiment of the present invention to provide a system and method for data acquisition and processing which is suited to online gaming such as online casinos wherein a captured datagram is combined with details of the device capturing it such as the mobile phone make and model and or information about the SIM card owner or subscription holder and transmitted to the remote server such that the correct software application can be transmitted as well as being able to verify whether the subscription holder has a good credit rating and or is above a specific age.

It is a further object of one embodiment of the present invention to provide a system and method for data acquisition and processing which may form the basis of a new and exciting datagram lottery game in which datagrams may be unique and one or more datagrams comprise winning images among a large number of printed or displayed datagrams wherein capturing and sending one or more of these datagrams to a remote server may result in the sender winning a prize or access to products and or services.

It is a further object of one embodiment of the present invention to provide a system and method for data acquisition and processing which may form the basis of a new and exciting datagram lottery game in which there are a large number of issued datagrams and wherein a small number of datagrams may be identical such that only these datagrams represent winning tickets and wherein capturing and sending one or more of these datagrams to a remote server may result in the sender winning a prize or access to products and or services.

It is a further object of one embodiment of the present invention to provide a system and method for data acquisition and processing which involves capturing a coloured datagram and transmitting it to a remote server and remote processing of the received datagram wherein an application is sent back to the capturing device to modify and or control the optics of the capturing device such as to change the sensitivity of different frequency ranges of the camera and form a selective complex optical filter and thereby make possible the capture of a different combination of visible elements of the datagram which would be unknown to the person operating the capturing device and wherein the new filtered datagram could then be retransmitted to a remote server and be processed to access specific content or services.

It is a further object of one embodiment of the present invention to provide a system and method for data acquisition and processing which involves capturing a coloured datagram for transmission and remote processing which causes the downloading of one of a plurality of selective software filters for the camera optics of the capturing device wherein different selective software filters may be generated to form part of a game wherein only a particular filter when downloaded will cause the datagram to generate an encoded symbol which may result in a prize or a change of status condition.

It is a further object of one embodiment of the present invention to provide a system and method for data acquisition and processing which involves capturing a black and white and or coloured datagram for transmission and remote processing which causes the downloading of an image file filter which when combined with the captured datagram creates the generation of a new image such as a letter or combination of symbols or the like such that the image filter file might modify parts of the captured datagram to create the said new image.

It is a further object of one embodiment of the present invention to provide a system and method for data acquisition and processing which has direct application to televised media or multimedia content wherein the media or content comprises datagrams which may be viewed on screen and which may be captured during viewing and transmitted to an on-screen number or to a pre-programmed number and wherein a remote server associated with the said number transmits content or details of advertised products and or services back to the device from which the datagram was received or to an associated and possibly pre-registered email address.

It is a further object of one embodiment of the present invention to provide a system and method for data acquisition and processing which has direct application to online gaming wherein a player must capture an image displayed on a screen which comprises some changing content such as a countdown timer or other moving feature such as a bar chart increasing in height or the like wherein the capture of the level or position of the changing feature may be used in combination with the image to access a particular service or to enter a competition or access content.

It is a further object of one embodiment of the present invention to provide a system and method for data acquisition and processing which has direct application to televised media or multimedia content wherein datagrams are displayed during commercials so that viewers may register their interest in the said products by simply capturing and transmitting the datagrams to a pre-stored or an on-screen number.

It is a further object of one embodiment of the present invention to provide a system and method for data acquisition and processing which has direct application to televised media such as game shows and in particular to game shows where viewers may vote for contestants or a situation in the show to influence a desired outcome wherein each contestant or outcome is associated with a datagram wherein a viewer captures the specific associated datagram and transmits it to register a vote.

It is a further object of one embodiment of the present invention to provide a system and method for data acquisition and processing which has direct application to televised media such as game shows wherein a viewer captures a single datagram from the screen and in response receives a software application which temporarily or permanently pre-programmes voting options into the device such as under particular buttons and wherein at the end of the game the pre-programmed options may be deleted and the device is reset to its pre-game settings.

It is a further object of one embodiment of the present invention to provide a system and method for data acquisition and processing which may comprise several steps such that a first datagram is captured and sent to a central network address or phone number which may act as a service director and wherein a remote server processes that datagram and then delivers a second network address back to the capturing device so that the device becomes programmed with features and IP addresses and or phone numbers automatically to access a particular set of services. In this way a diversity of services can be accessed which correspond to different linking addresses wherein the user does not need to key in these numbers himself.

Other objects and advantages of this invention will become apparent from the description to follow when read in conjunction with the accompanying drawings.

### BRIEF SUMMARY OF THE INVENTION

Certain of the foregoing and related objects are readily-attained according to the present invention by the provision of a novel system and method for data acquisition and processing which can form the basis of new and exciting consumer services which involve the use of the mobile phone or PDA or fixed line device to capture datagrams and transmit these to be processed remotely and whereby the decoding of the datagram results in a reprogramming of the capturing device. This method makes it possible to download a whole range of software upgrades and content by simply capturing a photo of an image from a printed page or from a screen.

The invention is particularly directed at online gaming and online casinos by providing a simple set-up procedure just one click away.

Television and multimedia advertising may also benefit from the invention by providing the means to request products from televised adverts by simply capturing a displayed datagram such as an encoded image or barcode or picture with some varying content.

The invention also provides an improved solution for game shows where viewers may vote for a contestant or influence a preferred outcome in a show.

Other objects and features of the present invention will become apparent from the following detailed description considered in connection with the accompanying drawings, which disclose several key embodiments of the invention. It is to be understood, however, that the drawings are designed for the purpose of illustration only and that the particular applications are given by way of example only and do not limit the scope of the invention.

### BRIEF DESCRIPTION OF THE DRAWINGS

FIG. 1 illustrates a schematic showing how a handheld device can access and download and activate a gaming application such as an online casino according to one embodiment of the invention.

FIG. 2 illustrates a schematic showing how a pre-programmed number is used to link to one of a plurality of datagram driven services.

FIG. 3 illustrates a schematic showing how a viewer may interact with televised commercials and request information of products and services.

FIG. 4 illustrates a schematic showing how a viewer may interact with a game show which permits real-time voting.

FIG. 5 illustrates an example of a lottery ticket game based upon a datagram

FIG. 6 illustrates how a captured datagram can cause the downloading of a software control filter which can modify the sensitivity of different frequency ranges of the optics and thereby read hidden data in an image.

FIG. 7 illustrates how a how a captured datagram can cause the downloading of an image filter which when combined with the viewed datagram modifies the image to generate a new image which can be used to generate an image key for access to services.

### DESCRIPTION OF A PREFERRED EMBODIMENT

Reference will now be made in detail to some specific embodiments of the invention including the best modes contemplated by the inventor for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as defined by the appended claims. The following description makes full reference to the detailed features as outlined in the objects of the invention.

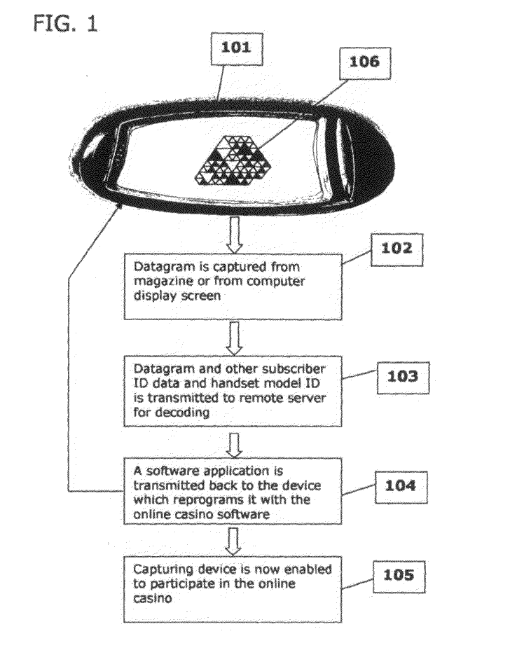

Referring now in detail to the drawings and in particular FIG. 1 thereof, therein illustrated is a schematic of one example showing how an online gaming application may be downloaded from a remote server according to the current invention.

A wireless device such as a multimedia computer (101) comprising a digital camera captures a data-encoded image (106) which contains data relating to service activation. The data-encoded image may be displayed upon the capturing device as shown.

As indicated in the sequence of 4 actions, the following processes then occur. Firstly, (102) the multimedia computer captures the datagram image from a computer screen or a television advert or a magazine.

Next, (103) the captured datagram is combined with identification data such as the SIM ID or device identity number and the device make and model number and this is then transmitted to a remote server for decoding. This can be done by simply sending the datagram and additional data to be processed by the server.

In this phase the server can make the appropriate online checks to establish the credit status of the player and or the age of the subscription holder and or any other data needed for authentication.

After the server has decoded the datagram and taken into consideration the status of the subscription and the relevance of the identity data, a software application which suits the make and model of the device is transmitted (104) to the device. The application reprograms the device with the application and launches the online casino software.

The device is thus primed to participate in an online game (105).

In this particular part of the description it is to be understood that all manner of software may be uploaded to a wireless device using this method of datagram capture.

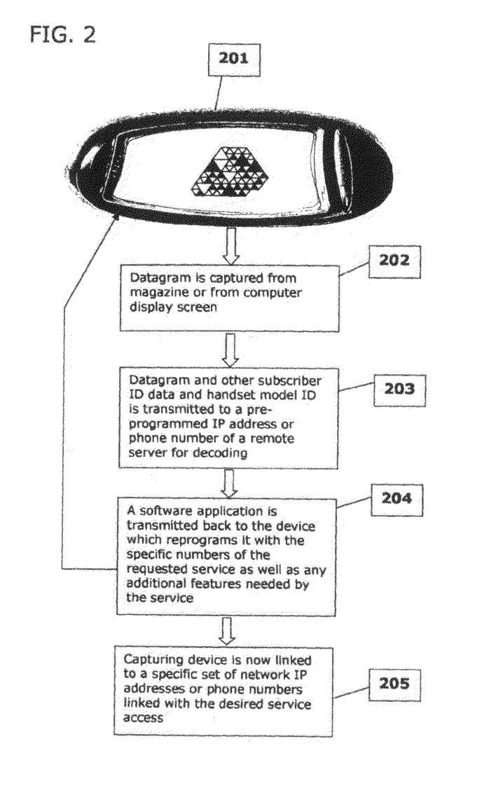

Now with reference to FIG. 2 is shown how a pre-programmed number may be used to link to one of a plurality of datagram driven services.

In this embodiment, the access to one of a plurality of datagram driven services is effected by sending the captured datagram to a pre-programmed number which will provide the linking numbers and any additional software features automatically by programming the device with the needed data.

In this embodiment the device (201) captures a datagram (202) and transmits this with ID data to a single pre-programmed number (203). This corresponds to a first stage decoding process where additionally, access rights to the authorised services may be determined or refused depending upon identification data which is sent with the captured datagram.

After decoding the datagram and processing the accompanying identification data the remote server sends back a confirmation and an application (204) which may automatically install the particular IP addresses and or phone numbers which relate to the desired application and installs any additional software features which are needed to run the application.

Following installation, the device is now programmed to be linked to access the desired service (205).

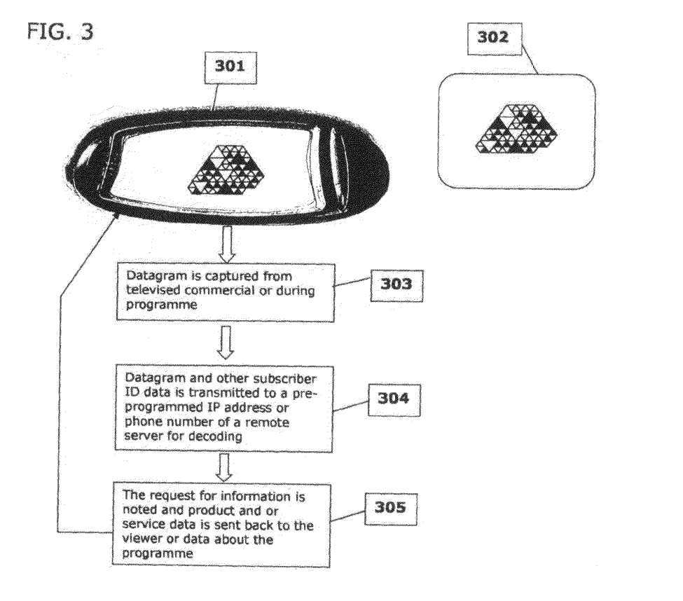

Now with reference to FIG. 3 is shown a sequence of actions which enables a viewer to interact with televised commercials and or television programmes and request information about products and services and or data about a particular programme.

First a PDA or mobile phone (301) captures a data-encoded image (303) from a televised programme (302) or during a commercial. The datagram and other identification data such as an email address is transmitted to a pre-programmed number (304). The remote server processes the request for data and responds by sending back data directly to the requesting device and or to an associated email address (305).

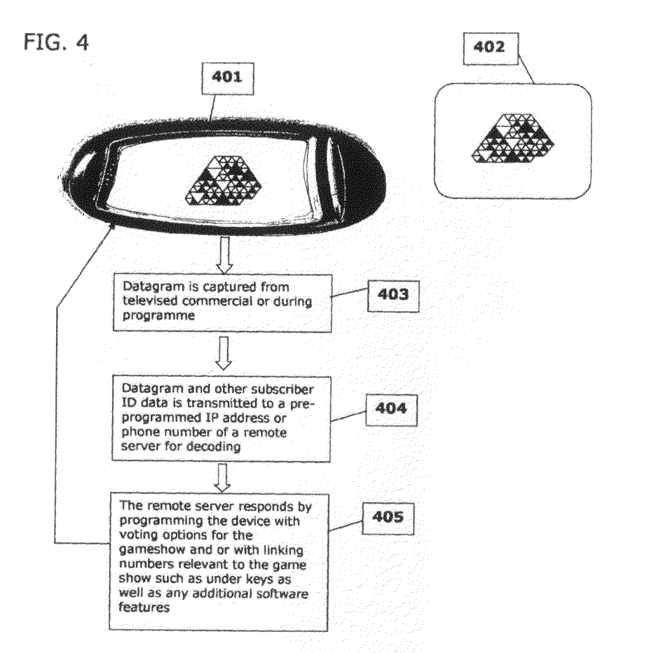

Now with reference to FIG. 4 is shown how a viewer may make use of the current invention to interact with a televised game show and vote for a contestant or influence the outcome of a particular game show situation.

There are many possible variants to implement this. The viewer may simply capture a datagram corresponding to a contestant when it is displayed on the screen or from a program guide and transmit this to a pre-programmed or a displayed number. Alternatively, the game show may comprise more voting options and all these options may be programmed into the device after the viewer has captured and sent a first datagram to a particular number. The remote server sends back the application to do this which self-installs on the device.

On the screen, the user will see the status of the voting. Either at the bottom of the screen or displayed next to a contestant or voting option there will be a dynamic image and or number showing the number of votes and or the frequency of votes. This creates an exciting feedback of the voting status on screen and will encourage voters to keep voting. This may comprise rising colour bars or a superposed arrow moving between the different contestants, or involve a change in colour of voting status from green to red. As soon as the voting possibility is over the display will indicate that voting is closed and the dynamic images will freeze.

First the device (401) captures a datagram (403) displayed on the television screen (402) during broadcast of the game show programme.

Some identification data and the datagram ID is transmitted to a remote server for decoding (404). In one embodiment this may comprise the actual vote where a particular datagram corresponds to a particular contestant but in a second embodiment, the remote server responds by sending back a software application which is then installed on the device and which provides features and voting options relevant to the game during its broadcast (405). The voting options and software features remain operational during the game, show but may be disabled by a simple message or a sound key transmitted by the programme as soon as voting options are closed. In this way the viewer does not spend money to vote after the voting process is closed.

Audio keys transmitted by the programme may also be used to open and close the voting by interacting with the software application. This may be preferable to sending a particular message to every device. The audio key may be a simple siren or note or it may be a sequence of coded sounds which the application recognises. A message may then appear on the screen of the device as soon as this voting-closed status is reached during the show. Particular audio keys may also drive other parts of the application and form online gaming options to enhance the viewer experience further.

In the same way that the datagrams are shown on the screen, the number of votes can be collected in real time and displayed as a changing symbol.

This provides a dynamic and real-time update of the current status of the voting. Standard text messages as well as datagram messages may be combined to provide a real time frenzy of the status of all the votes.

This also provides the viewer with an impetus to carry on voting as he or she sees their favourite candidate in need of additional votes.

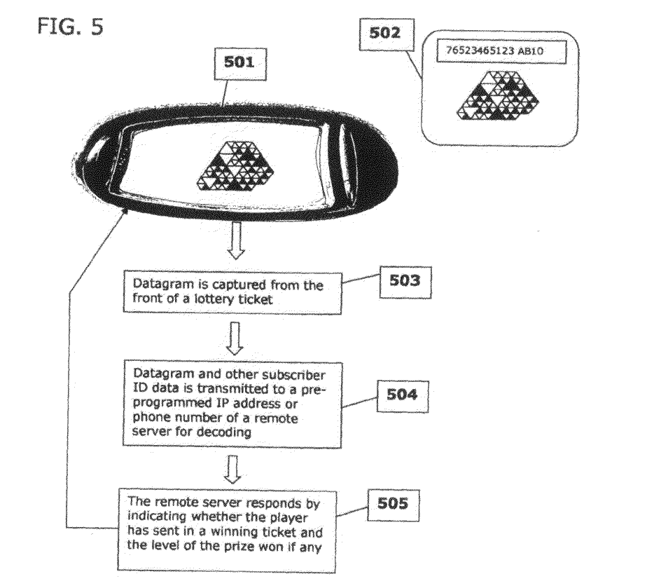

Now with reference to FIG. 5 is shown how the datagram can be combined to form a picture lottery ticket where the datagram may comprise unique features which when captured and submitted may win a prize or provide access to products or services.

Firstly the device (501) captures a datagram image from the front of a lottery ticket (502) or from a computer display screen such as from a web page. The datagram may be software generated on the screen and may comprise some dynamically changing features.

The datagram is then transmitted to a remote server together with identification data of the player (504). In some instances, an authentication check may be used to verify that the player is above the necessary age to participate.

The remote server then responds by indicating whether the player has sent in a winning ticket and the level of the prize won if any (505).

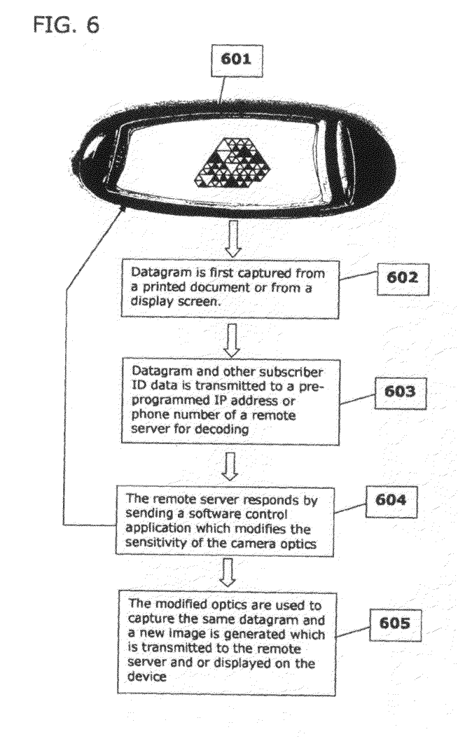

Now with reference to FIG. 6 is shown how a captured coloured datagram can be used to cause the downloading of a software control filter which can modify the sensitivity of the camera optics and thereby change the way the camera detects light of different frequency ranges. In this way the modified device will read the same datagram image but since the image is coloured, parts of the image will appear brighter and other parts will disappear. The software control filter can be directly related to personal ID data sent to the server and thus the method provides a means to authenticate and or authorise access to services if the generated key is valid.

A particular user will receive a personalised control filter which may be based upon the device identity and or input data such as PIN code or spoken phrase or bio data such as a finger print. This personalised dataset will uniquely encode the control filter and with reference to any stored data, can be used to generate a key.

The datagram is captured (602) on the screen of the device (601). Personal ID data is then transmitted to a pre-programmed phone number or IP address of a remote server where the datagram is decoded (603). The remote server responds by sending a software control application which installs to modify the optics of the camera (604). The previous optics control software values may be stored to reprogram the default values after the control application has been used.

The modified optics are used to capture the same datagram and a new image is generated which is transmitted to the remote server and or displayed on the screen of the device (605). In this application a unique key may be generated which can be used to authenticate a person remotely by requesting a PIN or other BIO data which is compared with what is stored.

Applications for this feature include ATM bank cash withdrawal systems, door access and other security applications.

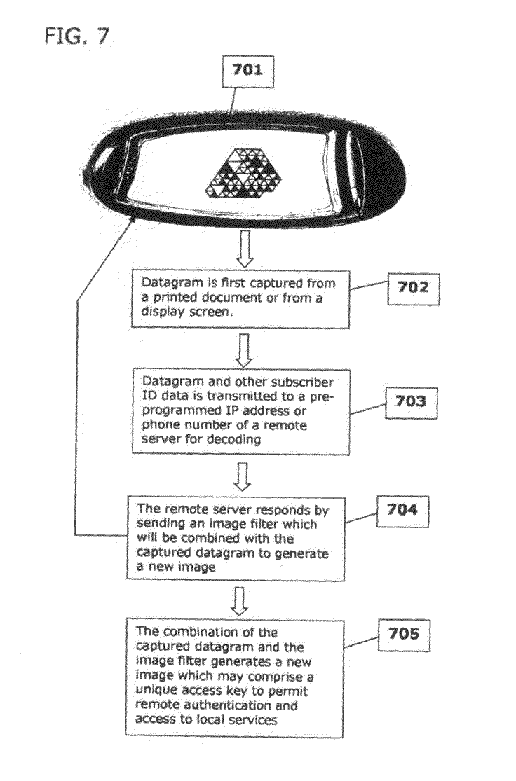

Now with reference to FIG. 7 is shown how a captured datagram can cause the downloading of an image filter which when combined with the captured datagram can modify the image by removing parts of it in a controlled way to generate a new image which can be used to generate a key to access services or to authenticate a person remotely. In this example the datagram may be colour or black and white.

First the device (701) captures a datagram (702) which is then transmitted with personal ID data such as BIO fingerprint data and or SIM identity data and or a PIN number to a remote server for decoding (703). The remote server responds by sending back an image filter application which combines the captured datagram image with the image filter image to generate a new image. This new image is based upon unique personalised data and the screen may request additional ID input based upon data stored at the remote server.

The combination of different personalised data with the new image may be used to generate a unique valid and authentic key to permit a remotely authenticated person to gain access to local services such as cash withdrawal, door access and other security applications.

While the present invention has been described herein with reference to particular embodiments thereof, a latitude of modification, various changes, and substitutions are intended in the present invention. In some instances, features of the invention can be employed without a corresponding use of other features, without departing from the scope of the invention as set forth. Therefore, many modifications may be made to adapt a particular configuration or method disclosed, without departing from the essential scope and spirit of the present invention. It is intended that the invention not be limited to the particular embodiments disclosed, but that the invention will include all embodiments and equivalents falling within the scope of the claims.

1. Data acquisition and processing system comprising a wireless device (101) being a mobile phone or PDA or wireless laptop or a multimedia computer comprising a digital camera for capturing a datagram and means for processing said datagram and transmitting said datagram to a remote server for decoding said captured and/or processed and transmitted datagrams for accessing services, said system being characterised in that:
said datagram being a data-encoded image (106) containing data relating to a service activation, wherein said datagram image being captured from a computer screen or a television advert or during a television programme or commercial or a magazine or from the front of a lottery ticket or from a printed document, and
said means for processing further combining within a dataset said captured datagram (106) with identification data being the SIM ID or wireless device identity number, and said wireless device make and/or model number for further transmitting said dataset to a pre-programmed IP address or phone number of said remote server for decoding.

2. A data acquisition and processing system according to claim 1 wherein
said remote server comprising means for performing appropriate online checks for establishing the credit status of the sender and/or the age of the subscription holder and/or identity data needed for authentication, and when said checks being successful,
said remote server further comprising means for transmitting a software application back to said wireless device (101) wherein said software application suiting said make and said model of said wireless device (101), for reprogramming said wireless device (101) for allowing said wireless device (101) to operate said software application.

3. A data acquisition and processing system according to claim 2 wherein
said software application further comprising specific numbers of said requested service, and the additional features needed by said service for accessing said service, or
said transmitted dataset by said wireless device (101) further comprising a request for information, and wherein said software application further comprising product or service data or data about said television programme, and/or said product or service data or data about said television programme being sent to a pre-registered E-mail address.

4. A data acquisition and processing system according to claim 3 wherein
said software application being an online casino or a gambling game and further priming said wireless device (101) to participate in an online game, or
said captured datagram being unique and said remote server responding by indicating whether said player's ticket being a winning ticket and the level of the price won, and said sender finding if said captured datagram being a winning datagram or
said software application reprogramming said wireless device (601) for allowing said wireless device to modify the optics of the camera, and/or
said captured datagram being used to generate a unique key for authenticating said sender and authorising said sender to access services if said generated key being valid, wherein said services being ATM bank cash withdrawal systems or door access or local services.

5. Data acquisition and processing method comprising a wireless device (101, 201) being a mobile phone or PDA or wireless laptop or a multimedia computer comprising a digital camera for capturing a datagram and means for processing said datagram and transmitting said datagram to a remote server for decoding said captured and/or processed and transmitted datagrams for accessing services, said method comprising the steps of:
capturing a datagram image from a computer screen or a television advert or a magazine by said wireless device (102, 202),
combining said captured datagram with identification data comprising the SIM ID or device identity number and the device make and model number within a dataset, and
transmitting said dataset to a pre-programmed IP address or phone number of a remote server for decoding and processing said dataset by a remote server (103, 203).

6. A data acquisition and processing method according to claim 5 further comprising the steps of;
establishing the credit status of the user and/or the age of the subscription holder and/or other data needed for authentication by said remote server,
transmitting a software application suiting the make and model of said wireless device (101) back to said wireless device (101) by said remote server, wherein said software application reprogramming said wireless device (101) for allowing said wireless device (101) to operate said software application (104, 204).

7. A data acquisition and processing method according to claim 6 wherein said software application further comprising the steps of;
launching an online casino software and priming said wireless device (101) to participate in an online game (105) or
linking said wireless device (201) to access a desired service (205).

8. A data acquisition and processing method comprising a wireless device (301) being a mobile phone or PDA or wireless laptop or a multimedia computer comprising a digital camera for capturing a datagram and means for processing said datagram and transmitting said datagram to a remote server for decoding said captured and/or processed and transmitted datagrams for accessing services, said method comprising the steps of:
capturing a data-encoded image (303) from a televised programme (302) or during a commercial by a PDA or mobile phone (301),
transmitting said datagram and identification data by said PDA or mobile phone (301) wherein said identification data comprising an email address to a pre-programmed number (304),
processing the request for data by a remote server, and
responding by sending back product or service data or data about said television program directly to the requesting device (301) and/or to an associated Email address (305).

9. A data acquisition and processing method comprising a wireless device (401) being a mobile phone or PDA or wireless laptop or a multimedia computer comprising a digital camera for capturing a datagram and means for processing said datagram and transmitting said datagram to a remote server for decoding said captured and/or processed and transmitted datagrams for accessing services, said method comprising the steps of:
capturing a datagram image from a televised game show or during a programme from a television screen (402) by said wireless device (401),
combining said captured datagram with identification data comprising the SIM ID or device identity number and/or the device make and model number within a dataset, and
transmitting said dataset to a pre-programmed IP address or phone number of a remote server for decoding and processing said dataset by a remote server (404).

10. A data acquisition and processing method according to claim 9 further comprising the steps of;
transmitting a software application suiting said make and model of said wireless device (401) back to said wireless device (401) by said remote server, wherein said software application reprogramming said wireless device (401) for providing said wireless device (401) with features and voting options relevant to the game during its broadcast (405).

11. A data acquisition and processing method according to claim 10 further comprising the steps of interacting with a televised game show and voting for a contestant or influence the outcome of a particular game show situation by a viewer, further comprising the steps of;
capturing a datagram by said viewer, wherein said datagram corresponding to a contestant when said datagram being displayed on the screen or from a program guide, or selecting one of a plurality of voting options being programmed into said wireless device (401) by said sent back software application, and
transmitting said captured or selected datagram to a pre-programmed or a displayed number by said viewer.

12. A data acquisition and processing method according to claim 11 wherein
the status of said voting being displayed on the screen, either at the bottom of said screen or next to a contestant or voting option, wherein said status being a dynamic image and/or number showing the number of votes and/or the frequency of votes, and
the voting options and software features remaining operational during the game show and being disabled by a simple message or a sound key wherein said sound key being a siren or note or a sequence of coded sounds, transmitted by said game show or said programme as soon as said voting options being closed.

13. A data acquisition and processing method comprising a wireless device (501) being a mobile phone or PDA or wireless laptop or a multimedia computer comprising a digital camera for capturing a datagram and means for processing said datagram and transmitting said datagram to a remote server for decoding said captured and/or processed and transmitted datagrams for accessing services, said method comprising the steps of:
capturing a datagram image from the front of a lottery ticket (503) or from a computer display screen displaying a web page, wherein said displayed datagram being software generated on said display screen and comprising some dynamically changing features, by said wireless device (501),
combining said captured datagram with identification data comprising the SIM ID or device identity number and/or the device make and model number within a dataset,
transmitting said dataset to a pre-programmed IP address or phone number of a remote server for decoding and processing said dataset by a remote server (504), and
establishing the credit status of the user and/or the age of the subscription holder and/or other data needed for authentication by said remote server, and
transmitting back to said wireless device (501) an indication whether said sent ticket being a winning ticket and/or the level of the prize won if any (505).

14. A data acquisition and processing method comprising a wireless device (601, 701) being a mobile phone or PDA or wireless laptop or a multimedia computer comprising a digital camera for capturing a datagram and means for processing said datagram and transmitting said datagram to a remote server for decoding said captured and/or processed and transmitted datagrams for accessing services, said method comprising the steps of:
capturing a coloured datagram image from a printed document or from a display screen by said wireless device (601, 701),
combining said captured datagram with identification data comprising the SIM ID or device identity number and/or the device make and model number within a dataset,
transmitting said dataset to a pre-programmed IP address or phone number of a remote server for decoding and processing said dataset by a remote server (603, 703), and
establishing the credit status of the user and/or the age of the subscription holder and/or other data needed for authentication by said remote server, and
transmitting a software application back to said wireless device (601, 701) wherein said software application suiting said make and said model of said wireless device (601, 701) by said remote server, wherein said software application being a software control filter suitable for modifying the sensitivity of said camera optics for changing the way said camera detecting light of different frequency ranges (601),
reprogramming said wireless device (601) for allowing said wireless device (601) to modify the optics of the camera (604), and
storing in said wireless device the default values in order to reprogram said default values.

15. A data acquisition and processing method according to claim 14 further comprising the steps of;
capturing said same datagram with said modified optics for generating a new image, and
transmitting to said remote server and/or displaying on the display screen of said wireless device (601) (605), for generating a unique key, or
combining said image filter with said captured datagram in order to modify the image by removing parts for generating a new image (701) (705) comprising a unique key.

16. A data acquisition and processing method according to claim 15 further comprising the steps of;
authenticating a person remotely by further requesting a PIN or spoken phrase or other BIO data being fingerprint, and comparing said PIN or fingerprint with what is stored, and
authorising access to services if said generated key being valid, wherein said services being ATM bank cash withdrawal systems or door access or local services.
